(19) United States
(12) Patent Application Publication
(10) Pub. No.: US 2026/0346696 A1
(43) Pub. Date: Nov. 5, 2026

(54) SPLIT AXIAL FLUX DUAL ROTOR ELECTRIC MOTOR HYBRID MODULE

(71) Applicant: Schaeffler Technologies AG & Co. KG, Herzogenaurach (DE)

(72) Inventors: Eric Ubelhart, Orrville, OH (US); Peter Rentfrow, Doylestown, OH (US)

(21) Appl. No.: 19/198,720

(22) Filed: May 5, 2025

(51) Int. Cl. B60K 6/40; B60K 6/26; B60K 6/442; H02K 5/24; H02K 7/08; H02K 7/108; H02K 21/24

(52) U.S. Cl. CPC B60K 6/40; B60K 6/26; B60K 6/442; H02K 5/24; H02K 7/088; H02K 7/108; H02K 21/24; B60K 2006/266; B60K 2006/268; B60Y 2200/92

(57) ABSTRACT

A hybrid module may include a split stator axial flux electric motor with dual rotors and a lockup clutch. The axial flux machines may be motor/generators. The stators of the axial flux machine may be disposed between the rotors, and supported by a support. The rotors may be radially constrained to the support. First and second of the axial flux machines may be affixed to input and output shafts. The lockup clutch may couple between the input and output shafts. A hybrid drive may include the hybrid module, power electronics, and a rechargeable battery. The power electronics may be configured as a pair of 3-phase units or a combined 6-phase unit. The power electronics may control the axial flux machines using pulse width modulation. A hybrid powertrain may include the hybrid drive coupling between an internal combustion engine and a transmission.

### TECHNICAL FIELD

The present disclosure generally relates to dynamo-electric machines for hybrid electric vehicles, and more particularly, to dynamo-electric machines of the series-parallel switching type.

### BACKGROUND

P2 hybrid modules may include a torque converter and a radial flux motor. The radial flux motor may be of the inner-rotor outer-stator type. The P2 hybrid modules may also include one or more clutches, such as a K0 clutch at the crankshaft of the engine and/or a K1 clutch as the transmission input shaft. The use of the P2 hybrid modules in hybrid electric vehicles may require customizing the transmission housing to enable receiving the torque converter, such as to enable receiving an impeller shell of the torque converter.

### SUMMARY

A hybrid module is described, in accordance with one or more embodiments of the present disclosure. The hybrid module may include: an input shaft; an output shaft; a lockup clutch being a closeable and openable coupling between the input shaft and the output shaft; a first axial flux machine including a first rotor and a first stator, the input shaft and the first rotor being affixed together, the first rotor and the first stator being axially offset, radially aligned, and configured to magnetically couple together; a second axial flux machine including a second rotor and a second stator, the output shaft and the second rotor being affixed together, the second rotor and the second stator being axially offset, radially aligned, and configured to magnetically couple together, the first axial flux machine and the second axial flux machine being configurable as motors and generators independently of each other; and a support, the first stator, the second stator, and the support being affixed together, the input shaft, the first rotor, the output shaft, and the second rotor being radially constrained to the support, the input shaft, the output shaft, the lockup clutch, the first axial flux machine, the second axial flux machine, and the support being coaxial.

In some aspects, the lockup clutch is one of a friction clutch, a disc clutch, or a hydrostatic clutch.

In some aspects, the input shaft and the first rotor are affixed together at an outer diameter of the first rotor, wherein the output shaft and the second rotor are affixed together at an inner diameter of the second rotor.

In some aspects, the hybrid module includes a first radial bearing and a second radial bearing, wherein the input shaft and the first rotor are radially constrained to the support via the first radial bearing, wherein the output shaft and the second rotor are radially constrained to the support via the second radial bearing.

In some aspects, an inner diameter of the first rotor abuts with an outer diameter of the first radial bearing, wherein an outer diameter of the output shaft abuts with an inner diameter of the second radial bearing.

In some aspects, the hybrid module includes a thrust bearing, wherein the output shaft and the second rotor are axially constrained to the input shaft via the thrust bearing.

In some aspects, an axial side of the second rotor which is facing away from the second stator abuts the thrust bearing, wherein the thrust bearing is disposed radially outwards of the lockup clutch.

In some aspects, the first axial flux machine and the second axial flux machine are axially offset.

In some aspects, the first rotor and the second rotor are disposed at opposing axial ends of the first axial flux machine and the second axial flux machine, wherein the first stator is axially disposed between the first rotor and the second stator, wherein the second stator is axially disposed between the first stator and the second rotor.

In some aspects, the first axial flux machine and the second axial flux machine are radially aligned.

In some aspects, the first axial flux machine and the second axial flux machine are each a single-stator, single-rotor configuration, wherein the first stator includes opposing axial sides which face towards respective of the first rotor and the second stator, wherein the second stator includes opposing axial sides which face towards respective of the first stator and the second rotor.

In some aspects, the hybrid module includes a first three-phase connection and a second three-phase connection, wherein the first rotor and the second rotor are permanent magnet rotors, wherein the first stator and the second stator are wound armature stators, wherein the first three-phase connection and the second three-phase connection are connected to respective of the first stator and the second stator, wherein at least a portion of the first three-phase connection and the second three-phase connection are disposed within the support.

In some aspects, the first axial flux machine and the second axial flux machine are magnetically insulated from each other.

In some aspects, the hybrid module includes a non-magnetic material, wherein the non-magnetic material is axially disposed between the first stator and the second stator.

In some aspects, the hybrid module includes a damper, wherein the damper is configured to damp torsional vibrations between the input shaft and the output shaft.

In some aspects, the lockup clutch and the second axial flux machine are configured to damp torsional vibrations between the input shaft and the output shaft.

A hybrid drive is described, in accordance with one or more embodiments of the present disclosure. The hybrid drive may include: a hybrid module including: an input shaft; an output shaft; a lockup clutch being a closeable and openable coupling between the input shaft and the output shaft; a first axial flux machine including a first rotor and a first stator, the input shaft and the first rotor being affixed together, the first rotor and the first stator being axially offset, radially aligned, and configured to magnetically couple together; a second axial flux machine including a second rotor and a second stator, the output shaft and the second rotor being affixed together, the second rotor and the second stator being axially offset, radially aligned, and configured to magnetically couple together, the first axial flux machine and the second axial flux machine being configurable as motors and generators independently of each other; and a support, the first stator, the second stator, and the support being affixed together, the input shaft, the first rotor, the output shaft, and the second rotor being radially constrained to the support, the input shaft, the output shaft, the lockup clutch, the first axial flux machine, the second axial flux machine, and the support being coaxial; a rechargeable battery; a first power electronics unit connected to the first stator and the rechargeable battery; and a second power electronics unit connected to the second stator and the rechargeable battery, the first power electronics unit and the second power electronics unit configured to generate a pulse width modulation signal (PWM signal) to regulate an electrical power supplied to or generated by respective of the first axial flux machine and the second axial flux machine.

In some aspects, one of: the first power electronics unit and the second power electronics unit are housed in separate units; or the first power electronics unit and the second power electronics unit are housed in a common unit.

In some aspects, the hybrid module is configurable with at least one of: a mode (201-1) wherein the lockup clutch is open, the first stator has the PWM signal turned off, the second stator has the PWM signal turned on, the first rotor is static, and the second rotor is rotating; a mode (201-2) wherein the lockup clutch is open, the first stator has the PWM signal turned on, the second stator has the PWM signal turned on, the first rotor is rotating, and the second rotor is rotating; a mode (201-3) wherein the lockup clutch is closed, the first stator has the PWM signal turned on, the second stator has the PWM signal turned on, the first rotor is rotating, and the second rotor is rotating; a mode (201-4) wherein the lockup clutch is open, the first stator has the PWM signal turned on, the second stator has the PWM signal turned off, the first rotor is rotating, and the second rotor is static; or a mode (201-5) wherein the lockup clutch is closed, the first stator has the PWM signal turned off, the second stator has the PWM signal turned off, the first rotor is rotating, and the second rotor is rotating.

A hybrid powertrain is described, in accordance with one or more embodiments of the present disclosure. The hybrid powertrain may include: a hybrid drive including: a hybrid module including: an input shaft; an output shaft; a lockup clutch being a closeable and openable coupling between the input shaft and the output shaft; a first axial flux machine including a first rotor and a first stator, the input shaft and the first rotor being affixed together, the first rotor and the first stator being axially offset, radially aligned, and configured to magnetically couple together; a second axial flux machine including a second rotor and a second stator, the output shaft and the second rotor being affixed together, the second rotor and the second stator being axially offset, radially aligned, and configured to magnetically couple together, the first axial flux machine and the second axial flux machine being configurable as motors and generators independently of each other; and a support, the first stator, the second stator, and the support being affixed together, the input shaft, the first rotor, the output shaft, and the second rotor being radially constrained to the support, the input shaft, the output shaft, the lockup clutch, the first axial flux machine, the second axial flux machine, and the support being coaxial; a rechargeable battery; a first power electronics unit connected to the first stator and the rechargeable battery; and a second power electronics unit connected to the second stator and the rechargeable battery, the first power electronics unit and the second power electronics unit configured to generate a pulse width modulation signal (PWM signal) to regulate an electrical power supplied to and generated by respective of the first axial flux machine and the second axial flux machine; an internal combustion engine affixed to the input shaft; and a transmission affixed to the output shaft.

It is to be understood that both the foregoing general description and the following detailed description are exemplary and explanatory only and are not necessarily restrictive of the present disclosure. The accompanying drawings, which are incorporated in and constitute a part of the specification, illustrate subject matter of the disclosure. Together, the description and drawings serve to explain the principles of the disclosure.

### BRIEF DESCRIPTION OF THE DRAWINGS

The numerous advantages of the disclosure may be better understood by those skilled in the art by reference to the accompanying figures in which:

FIG. 1A illustrates a simplified cross-section view of a hybrid module with a pair of axial flux machines and a damper, in accordance with one or more embodiments of the present disclosure.

FIG. 1B illustrates a simplified cross-section view of a hybrid module with the pair of axial flux machines and without the damper, in accordance with one or more embodiments of the present disclosure.

FIG. 2A illustrates a simplified view of a hybrid drive with the hybrid module, in accordance with one or more embodiments of the present disclosure.

FIG. 2B-2F illustrates the hybrid module configured in various modes, in accordance with one or more embodiments of the present disclosure.

FIG. 3 illustrates a simplified view of a hybrid powertrain with the hybrid drive, in accordance with one or more embodiments of the present disclosure.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Embodiments of the present disclosure are directed to a split axial flux dual rotor electric motor hybrid module. The hybrid module may include a split stator axial flux electric motor with dual rotors and a lockup clutch. The axial flux machines may be motor/generators. The stators of the axial flux machine may be disposed between the rotors, and supported by a support. The rotors may be radially constrained to the support. First and second of the axial flux machines may be affixed to input and output shafts. The lockup clutch may couple between the input and output shafts. A hybrid drive may include the hybrid module, power electronics, and a rechargeable battery. The power electronics may be configured as a pair of 3-phase units or a combined 6-phase unit. The power electronics may control the axial flux machines using pulse width modulation. A hybrid powertrain may include the hybrid drive coupling between an internal combustion engine and a transmission.

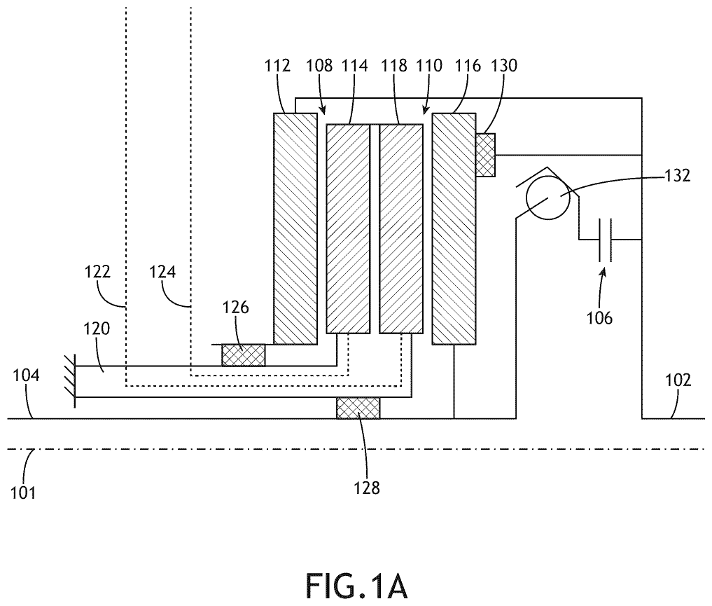

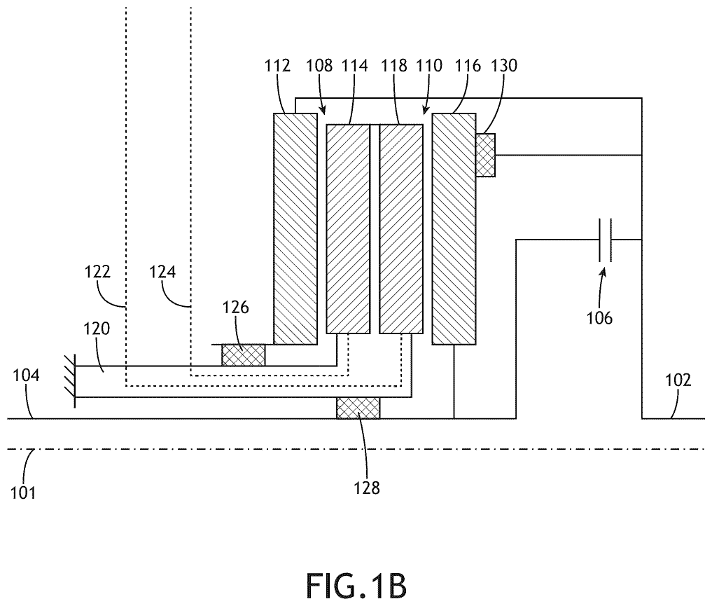

FIGS. 1A-1B illustrate a hybrid module 100, in accordance with one or more embodiments of the present disclosure. The hybrid module 100 may also be referred to as a P2 hybrid module, a split stator axial flux machine, a split axial flux dual rotor electric motor hybrid module, or the like.

The hybrid module 100 may include one or more components, such as, but not limited to, an input shaft 102, an output shaft 104, a lockup clutch 106, a first axial flux machine 108, a second axial flux machine 110, a first rotor 112, a first stator 114, a second rotor 116, a second stator 118, a support 120, a first three-phase connection 122, a second three-phase connection 124, a first radial bearing 126, a second radial bearing 128, a thrust bearing 130, and/or a damper 132.

One or more components of the hybrid module 100 may be coaxial to a center axis 101 of the hybrid module 100. For example, the input shaft 102, the output shaft 104, the lockup clutch 106, the first axial flux machine 108, the second axial flux machine 110, the first rotor 112, the first stator 114, the second rotor 116, the second stator 118, the support 120, the first radial bearing 126, the second radial bearing 128, the thrust bearing 130, and/or the damper 132 may be coaxial to the center axis 101 of the hybrid module 100. The first three-phase connection 122 and/or the second three-phase connection 124 may or may not be coaxial to the center axis 101. The hybrid module 100 may be considered an on-axis design by the components being coaxial to the center axis 101.

The input shaft 102 and the output shaft 104 may each couple torque into and out of the hybrid module 100. The input shaft 102 and the output shaft 104 may include splines (not depicted) for coupling torque into and out of the hybrid module 100. The splines may be external splines or internal splines. The input shaft 102 may also be referred to as a module input shaft, an engine-side shaft, a crankshaft-to-module input shaft, or the like. The input shaft 102 may couple torque into and/or out of the hybrid module 100 as a drive from or to, respectively, an internal combustion engine (e.g., internal combustion engine 302). The output shaft 104 may also be referred to as a module output shaft, a transmission-side shaft, a module-to-transmission output shaft, or the like. The output shaft 104 may couple torque into and out of the hybrid module 100 as backlash or a drive, respectively, from a transmission (e.g., transmission 304).

The input shaft 102 and the output shaft 104 may be axially offset. For example, the input shaft 102 and the output shaft 104 may be axially offset by the lockup clutch 106 and/or the damper 132.

The lockup clutch 106 may be a closeable and openable coupling between the input shaft 102 and the output shaft 104. The lockup clutch 106 may couple and uncouple the input shaft 102 and the output shaft 104 when the lockup clutch 106 is respectively closed and opened. The lockup clutch 106 may transmit torque between the input shaft 102 and the output shaft 104 when closed and permit relative rotation between the input shaft 102 and the output shaft 104 when open. The lockup clutch 106 may be beneficial for directly driving the output shaft 104 from the input shaft 102 and improve the efficiency of the hybrid module 100 by avoiding inefficiencies associated with the first axial flux machine 108 and the second axial flux machine 110. The lockup clutch 106 may be actuatable between being closed and open. Closed may also be referred to locked, engaged, or the like. Open may also be referred to as unlocked, disengaged, released, or the like. The lockup clutch 106 may include any suitable type of clutch which may be actuatable between being closed and open, such as, but not limited to, a friction clutch, a disc clutch, a hydrostatic clutch, or the like.

The hybrid module 100 may also include the first axial flux machine 108 and the second axial flux machine 110. The first axial flux machine 108 may include the first rotor 112 and the first stator 114. The second axial flux machine 110 may include the second rotor 116 and the second stator 118. The first rotor 112 and the second rotor 116 may be radially aligned with and axially offset from respective of the first stator 114 and the second stator 118. The first rotor 112 and the second rotor 116 may be axially separated by gaps from respective of the first stator 114 and the second stator 118. The gaps may be air-gaps.

The input shaft 102 and the first rotor 112 may be affixed together. For example, the input shaft 102 and the first rotor 112 may be affixed together at an outer diameter of the first rotor 112. The input shaft 102 and/or the first rotor 112 may be radially constrained to the support 120. For example, the input shaft 102 and/or the first rotor 112 may be radially constrained to the support 120 via the first radial bearing 126. For instance, an inner diameter of the first rotor 112 may abut with an outer diameter of the first radial bearing 126, forming the radially constraint. The radial constraint may prevent radial translation and may allow rotation of the input shaft 102 and the first rotor 112 relative to the support 120 about the center axis 101. Thus, the input shaft 102 and/or the first rotor 112 may be configured to relative to the support 120.

The first stator 114, the second stator 118, and/or the support 120 may be affixed together. For example, the support 120 may be affixed to inner diameters and/or axial sides of the first stator 114 and/or the second stator 118.

The output shaft 104 and the second rotor 116 may be affixed together. For example, the output shaft 104 and the second rotor 116 may be affixed together at an inner diameter of the second rotor 116. The output shaft 104 and/or the second rotor 116 may be radially constrained to the support 120. For example, the output shaft 104 and/or the second rotor 116 may radially constrained to the support 120 via the second radial bearing 128. For instance, an outer diameter of the output shaft 104 may abut with an inner diameter of the second radial bearing 128, forming the radial constraint. The radial constraint may prevent radial translation and may allow rotation of the output shaft 104 and the second rotor 116 relative to the support 120 about the center axis 101. Thus, the output shaft 104 and/or the second rotor 116 may be configured to relative to the support 120.

The support 120 may support one or more components of the hybrid module 100. For example, the first stator 114, the second stator 118, the first three-phase connection 122, and/or the second three-phase connection 124 may be affixed to and supported by the support 120. By way of another example, the first rotor 112 and/or the second rotor 116 may be radially supported by the support 120 via respective of the first radial bearing 126 and the second radial bearing 128. The support 120 may provide a means for mounting the first rotor 112 and second rotor 116 relative to respective of the first stator 114 and the second stator 118 with the axial sides facing each other and with the gaps.

The output shaft 104 and/or the second rotor 116 may be axially constrained to the input shaft 102. For example, the output shaft 104 and/or the second rotor 116 may be axially constrained to the input shaft 102 via the thrust bearing 130. For instance, an axial side of the second rotor 116 which is facing away from the second stator 118 may abut the thrust bearing 130. The axial constraint may prevent axial translation and may allow rotation of the output shaft 104 and/or the second rotor 116 relative to the input shaft 102 about the center axis 101. The thrust bearing 130 may bear axial loads between the input shaft 102 and the second rotor 116. The thrust bearing 130 may permit the output shaft 104 and/or the second rotor 116 to rotate relative to the input shaft 102 while maintaining the axial constraint. The thrust bearing 130 may be disposed at any suitable radial and/or axial position. For example, the thrust bearing 130 may be disposed radially outwards of the lockup clutch 106 and/or the damper 132.

The first axial flux machine 108 and the second axial flux machine 110 may be axially offset from each other. For example, the first rotor 112, the first stator 114, the second rotor 116, and/or the second stator 118 may be axially offset from each other. The first rotor 112 and the second rotor 116 may be disposed at opposing axial ends of the first axial flux machine 108 and the second axial flux machine 110. The first stator 114 and the second stator 118 may be axially disposed between the first rotor 112 and the second rotor 116. For example, the first stator 114 may be axially disposed between the first rotor 112 and the second stator 118. By way of another example, the second stator 118 may be axially disposed between the first stator 114 and the second rotor 116. The first rotor 112 and the second rotor 116 may be split and not affixed together, such that the first rotor 112 and the second rotor 116 may rotate independently relative to the first stator 114, the second stator 118, and the support 120.

The first rotor 112 and the first stator 114 may be radially aligned. The second rotor 116 and the second stator 118 may be radially aligned. The first axial flux machine 108 and the second axial flux machine 110 may or may not be radially aligned. For example, the first rotor 112 and the first stator 114 may be radially aligned with the second rotor 116 and/or the second stator 118. Radially aligning the first axial flux machine 108 and the second axial flux machine 110 may be beneficial to maintain a consistent radial size of the first axial flux machine 108 and the second axial flux machine 110.

The first axial flux machine 108 and the second axial flux machine 110 may each be a single-stator, single-rotor configuration. For example, the first rotor 112 and the first stator 114 may form a single-stator, single-rotor configuration. By way of another example, the second rotor 116 and the second stator 118 may form a single-stator, single-rotor configuration. The first rotor 112, the first stator 114, the second rotor 116, and/or the second stator 118 may each include axial sides. One axial side of the first rotor 112 may face towards the first stator 114. Opposing axial sides of the first stator 114 may face towards respective of the first rotor 112 and the second stator 118. Opposing axial sides of the second stator 118 may face towards respective of the first stator 114 and the second rotor 116. One axial side of the second rotor 116 may face towards the second stator 118.

The first axial flux machine 108 and the second axial flux machine 110 may each be configured to generate magnetic flux. The first rotor 112 and the second rotor 116 may be configured to magnetically couple with respective of the first stator 114 and the second stator 118. For example, the first rotor 112 and/or the first stator 114 may generate magnetic flux which may pass through the gap to form the magnetic coupling therebetween. By way of another example, the second rotor 116 and/or the second stator 118 may generate magnetic flux which may pass through the gap to form the magnetic coupling therebetween. The magnetic flux may be aligned axially such that the first axial flux machine 108 and the second axial flux machine 110 are axial flux machines.

The first axial flux machine 108 and/or the second axial flux machine 110 may be configured as motors and/or generators depending upon which of the stator or rotor is the driven with power. The axial flux machines may be the motor, the generator, or a mechanical combination thereof, which can provide positive mechanical output force or torque and which can function at other times as an electric generator.

The first axial flux machine 108 and/or the second axial flux machine 110 may be configured as generators. The first axial flux machine 108 and/or the second axial flux machine 110 may be configured as generators for respective of the input shaft 102 and the output shaft 104. For example, the first axial flux machine 108 may be the generator when the first rotor 112 is driven by torque from the input shaft 102 causing the first stator 114 to generate electrical power. By way of another example, the second axial flux machine 110 may be the generator when the second rotor 116 is driven by torque from the output shaft 104 causing the second stator 118 to generate electrical power. The torque from the output shaft 104 may be driven by torque from the input shaft 102 through the lockup clutch 106 when the lockup clutch 106 is closed.

The first axial flux machine 108 and/or the second axial flux machine 110 may also be configured as motors. The first axial flux machine 108 and/or the second axial flux machine 110 may be configured as motors for respective of the input shaft 102 and the output shaft 104. For example, the first axial flux machine 108 may be the motor when the first stator 114 is driven by electrical power causing the first rotor 112 and the input shaft 102 to rotate. By way of another example, the second axial flux machine 110 may be the motor when the second stator 118 is driven by electrical power causing the second rotor 116 and the output shaft 104 to rotate.

The first axial flux machine 108 and the second axial flux machine 110 may be axial flux permanent magnet (AFPM) machines. The first rotor 112 and the second rotor 116 may be permanent magnet rotors. The first rotor 112 and the second rotor 116 may include rotor cores with permanent magnets (not depicted). The first stator 114 and the second stator 118 may be wound armature stators. The first stator 114 and the second stator 118 may also include armatures (not depicted). The permanent magnets and/or the armatures may be wedge-shaped (e.g., sector-shaped) and may be arranged in a polar array about the center axis 101. The polar array may include circumferentially positioning the permanent magnets and/or the armatures at equidistant from adjacent of respective of the permanent magnets and/or the armatures. Rotation of the rotors may induce current generation in the armatures of the rotors via the magnetic flux. Similarly, current supplied to the armatures may induce rotation of the permanent magnets through the permanent magnets via the magnetic flux. The permanent magnets of the first rotor 112 and the second rotor 116 may be circumferentially aligned with the armatures of respective of the first stator 114 and the second stator 118. The permanent magnets may face the armatures, as hub-type cycle dynamos.

The first three-phase connection 122 and the second three-phase connection 124 may be connected to respective of the first stator 114 and the second stator 118. The first three-phase connection 122 and the second three-phase connection 124 may be configured to carry electrical power (e.g., three-phase power) to and from respective of the first stator 114 and the second stator 118. For example, the connection may carry the electrical power to the stator when the axial flux machine is acting as the motor and may carry the electrical power away from the stator when the axial flux machine is acting as the generator. The depiction of the first three-phase connection 122 and the second three-phase connection 124 as single lines is not intended to be limiting. For example, the first three-phase connection 122 and the second three-phase connection 124 may each include three lines to carry the three-phase power. The first three-phase connection 122 and the second three-phase connection 124 may include any suitable connections, such as, but not limited to, wires, bars (e.g., copper bars), or the like.

At least a portion of the first three-phase connection 122 and the second three-phase connection 124 may be disposed within the support 120. For example, the portion of the first three-phase connection 122 and the second three-phase connection 124 may be disposed within the support 120 may be coupled to the inner diameters of respective of the first stator 114 and the second stator 118.

The first axial flux machine 108 and the second axial flux machine 110 may be configured as the motors and/or generators independently of each other. For example, the first axial flux machine 108 and the second axial flux machine 110 may each be configured as motors, may each be configured as generators, and/or one may be configured as a motor while the other is configured as the generator.

The first axial flux machine 108 and the second axial flux machine 110 may be magnetically insulated from each other. For example, the first stator 114 and the second stator 118 may be magnetically insulated from each other. Magnetically insulating the first stator 114 and the second stator 118 from each other may prevent the first stator 114 and the second stator 118 from interacting via the magnetic flux.

The first stator 114 and the second stator 118 may be magnetically insulated from each other via a non-magnetic material. The non-magnetic material may be axially disposed between the first stator 114 and the second stator 118. For example, the support 120 may be a non-magnetic material and a portion of the support 120 may be axially disposed the first stator 114 and the second stator 118. The non-magnetic material may include any material which a low-magnetic permeability which may block a magnetic flux between the first stator 114 and the second stator 118, such as, but not limited to, aluminum, non-magnetic stainless steels, or the like. Magnetically insulating the first axial flux machine 108 and the second axial flux machine 110 from each other may prevent the first axial flux machine 108 and the second axial flux machine 110 from jointly forming a single-stator, double-rotors configuration (e.g., an I-type axial flux motor) where both axial sides of the stator face to and magnetically couple with a pair of stators and/or from jointly forming a double-stator, single-rotor (e.g., an H-type axial flux motor) where both axial sides of the rotor face to and magnetically couple with a pair of stators. Thus, the support 120 may be a magnetically insulating casing.

The first stator 114 and the second stator 118 may also be magnetically insulated via the arrangement of the armatures of the first stator 114 and the second stator 118. The armatures (not depicted) of the first stator 114 and the second stator 118 may be circumferentially offset to reduce the interaction of the magnetic flux between the first stator 114 and the second stator 118.

Referring now to FIG. 1A, the hybrid module 100 may include the damper 132. The damper 132 may damp torsional vibrations between the input shaft 102 and the output shaft 104. Torsional vibrations from the input shaft 102 may be at least partially isolated from the output shaft 104 by the damper 132. The damper 132 may be disposed axially between the input shaft 102 and the output shaft 104. For example, the damper 132 may be disposed axially between the lockup clutch 106 and the output shaft 104. The damper 132 may include any suitable torsional damper, such as, but not limited to, a centrifugal pendulum absorber or the like. The damper 132 may also damp torque ripple from the second axial flux machine 110 (e.g., when the second axial flux machine 110 is acting as the motor for the output shaft 104).

Referring now to FIG. 1B, although the hybrid module 100 is described as including the damper 132, this is not intended as a limitation of the present disclosure. The function of the damper 132 may be replaced by the lockup clutch 106 and/or the second axial flux machine 110. The lockup clutch 106 and/or the second axial flux machine 110 may damp torsional vibrations between the input shaft 102 and the output shaft 104. For example, the lockup clutch 106 and/or the second axial flux machine 110 may be controlled via a sinusoidal control algorithm to maintain stability of the output shaft 104. The lockup clutch 106 may be allowed to slip open when there is torque backlash from the output shaft 104. The power to the second axial flux machine 110 may be modulated to counteract the torque coming back from the output shaft 104.

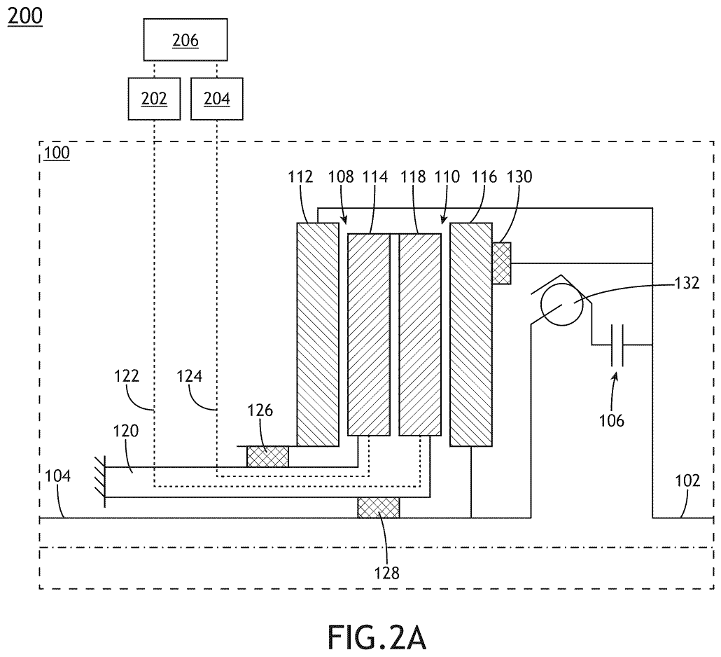

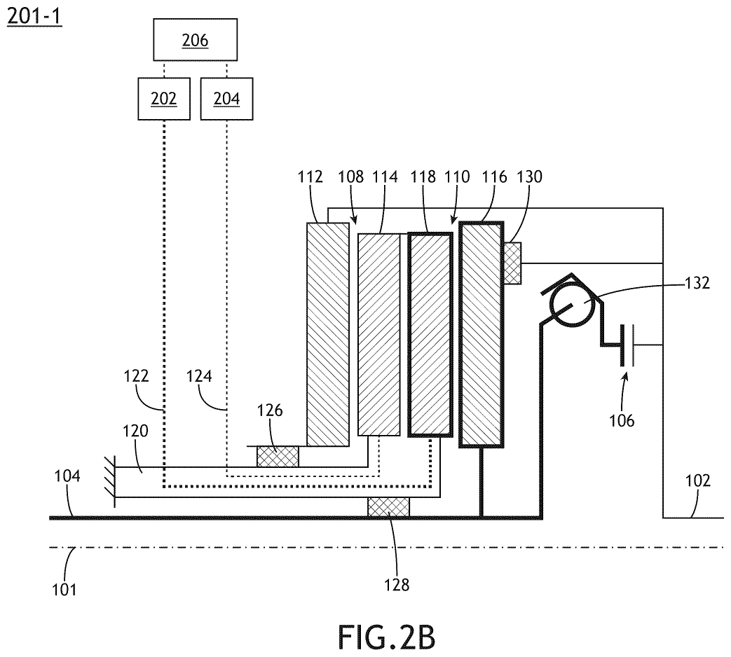

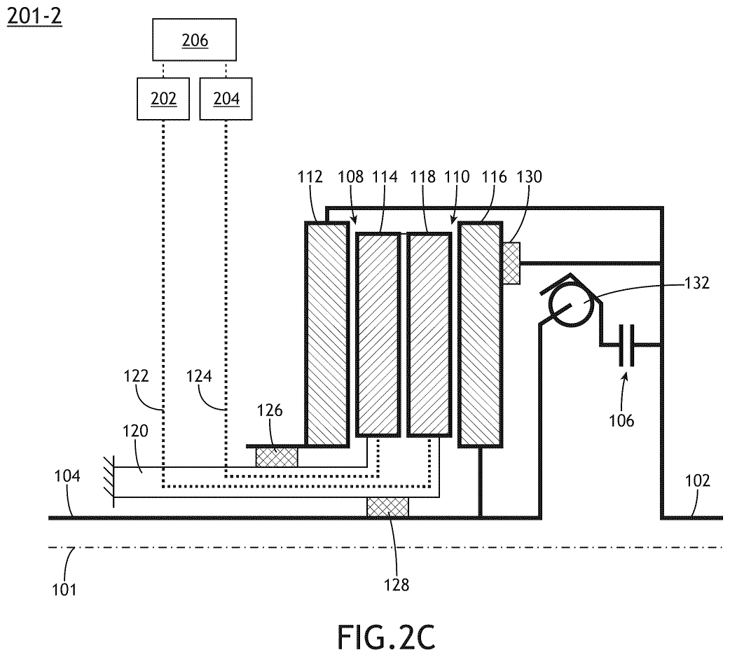

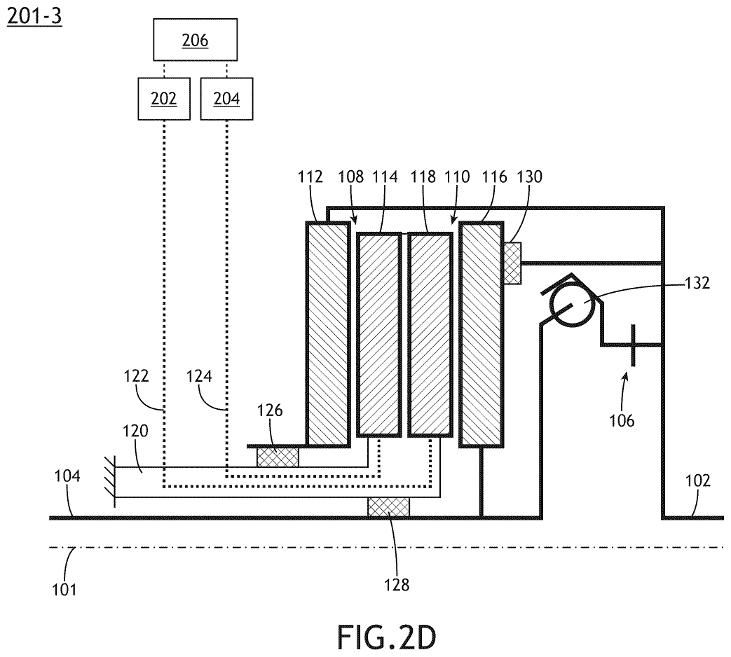

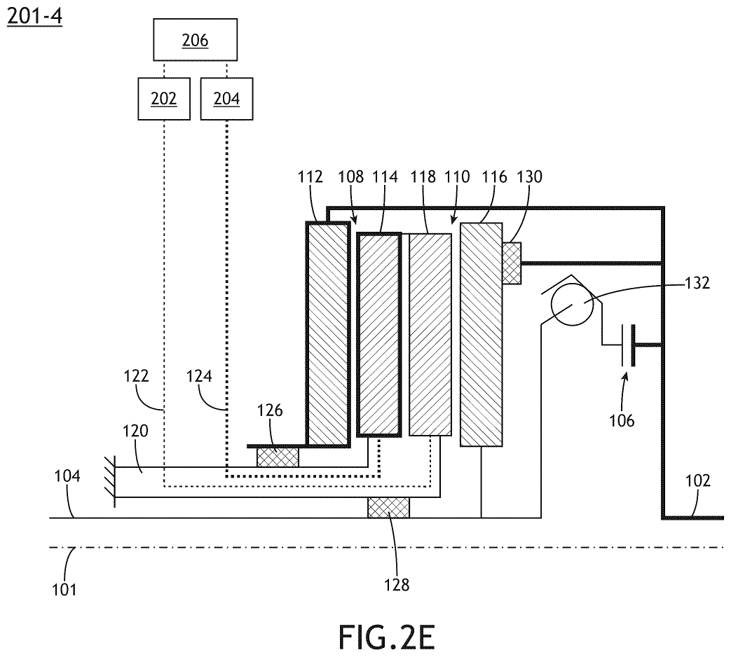

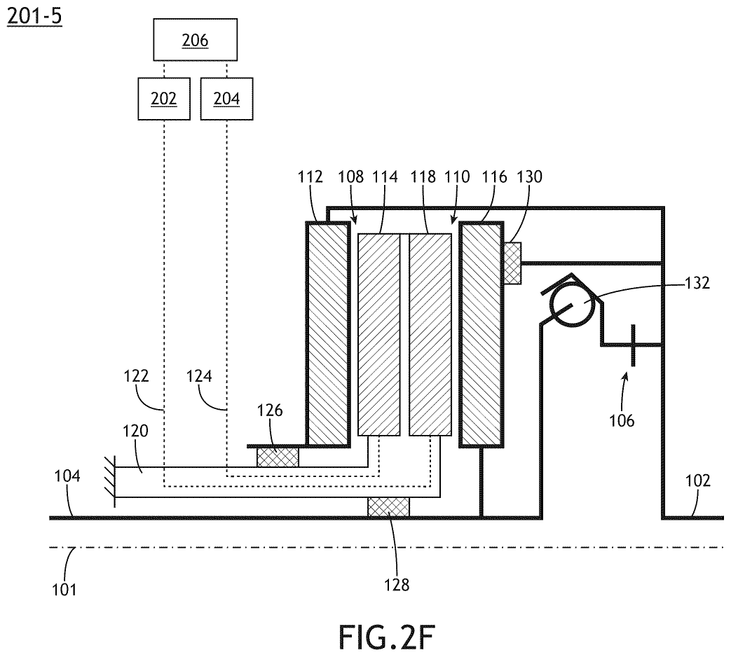

FIG. 2A-2F illustrate a hybrid drive 200, in accordance with one or more embodiments of the present disclosure. The hybrid drive 200 may be an electric mobility system. The hybrid drive 200 may include the hybrid module 100, a first power electronics unit 202 (PEU), a second power electronics unit 204, and/or a rechargeable battery 206.

The first power electronics unit 202 and the second power electronics unit 204 may be connected to respective of the first axial flux machine 108 and the second axial flux machine 110. For example, the first power electronics unit 202 and the second power electronics unit 204 may be connected to respective of first stator 114 and the second stator 118. For instance, the first power electronics unit 202 and the second power electronics unit 204 may also be connected to respective of first stator 114 and the second stator 118 via respective of the first three-phase connection 122 and the second three-phase connection 124.

The first power electronics unit 202 and the second power electronics unit 204 may be coupled to the rechargeable battery 206. For example, the first power electronics unit 202 and the second power electronics unit 204 may be coupled to the rechargeable battery 206 by a DC bus.

The rechargeable battery 206 may be rechargeable. For example, the rechargeable battery 206 may be rechargeable by the first power electronics unit 202 and/or the second power electronics unit 204. The rechargeable battery 206 may include any suitable battery which may be recharged. The rechargeable battery 206 may be a direct current (DC) battery.

The first power electronics unit 202 and/or the second power electronics unit 204 may also be referred to as power electronics, three-phase PWM rectifiers/inverters, or the like. The first power electronics unit 202 and/or the second power electronics unit 204 may be configured as inverters (e.g., a DC-to-three-phase AC converter) and/or rectifiers (e.g., a three-phase AC-to-DC converter). The axial flux machines may be configured as the motor when the power electronics are configured as the inverter. The axial flux machines may be configured as the generator when the power electronics are configured as the rectifier. The first power electronics unit 202 and/or the second power electronics unit 204 may include various components (not depicted) to configure the power electronics as the inverters, the rectifiers, and/or the pulse width modulators such as, but not limited to, bridges, filters, inductors, current sensors, voltage sensors, feedback control loops, and the like.

The first power electronics unit 202 and the second power electronics unit 204 may be housed in separate units (e.g., two separate three-phase inverter/rectifier units) or may be housed in a common unit (e.g., one common six-phase inverter/rectifier unit).

The first power electronics unit 202 and/or the second power electronics unit 204 may also be configured to generate pulse width modulation (PWM) signals to regulate the electrical power supplied to and/or generated by respective of the first axial flux machine 108 and the second axial flux machine 110. The PWM may control whether the inverter/rectifiers are on or off and/or whether the power electronics are controlling the axial flux motors. The first power electronics unit 202 and the second power electronics unit 204 may generate PWM signals for respective of the first axial flux machine 108 and the second axial flux machine 110. The PWM signals may be generated based on sensor signals one or more sensors (not depicted), such as, but not limited to, rotational speed sensors, rotary position sensors, current sensors, voltage sensors, or the like. For example, a first rotational speed sensor may sense the rotational speed of the input shaft 102 and/or the first rotor 112 while a second rotational speed sensor may sense the rotational speed of the output shaft 104 and/or the second rotor 116. The first power electronics unit 202 and the second power electronics unit 204 may use the sensor signals as feedback within current control loops using a look-up table or the like, for determining current magnitude and current angle when generating the PWM signals.

The hybrid module 100 may be configured with multiple modes. The hybrid module 100 be configured in the modes by the PWM signals from the first power electronics unit 202 and the second power electronics unit 204 and/or by opening and closing the lockup clutch 106. The first power electronics unit 202 and the second power electronics unit 204 may also control a current direction to and from the axial flux machines via the PWM signals. The modes may include a mode 201-1, a mode 201-2, a mode 201-3, a mode 201-4, and/or a mode 201-5. For example, the modes may be defined by the following table:

| Mode | 106 | 114 | 118 | 112 | 116 |
|---|---|---|---|---|---|
| 201-1 | Open | PWM off | PWM on | Static | Rotating |
| 201-2 | Open | PWM on | PWM on | Rotating | Rotating |
| 201-3 | Closed | PWM on | PWM on | Rotating | Rotating |
| 201-4 | Open | PWM on | PWM off | Rotating | Static |
| 201-5 | Closed | PWM off | PWM off | Rotating | Rotating |

The mode 201-1 may be an electric-only mode. In the mode 201-1, the lockup clutch 106 may be open, the first stator 114 may have the PWM signal turned off, the second stator 118 may have the PWM signal turned on, the first rotor 112 may be static, and the second rotor 116 may be rotating. There may be no torque input from the input shaft 102 such that the first rotor 112 and the input shaft 102 are static. The PWM signal to the second rotor 116 may cause the second rotor 116 and the output shaft 104 to rotate. The lockup clutch 106 being open prevents the rotation of the output shaft 104 from rotating the input shaft 102. Thus, the output shaft 104 does not affect the input shaft 102.

The mode 201-2 may be an open mode or an engine start mode. In the mode 201-2, the lockup clutch 106 may be open, the first stator 114 may have the PWM signal turned on, the second stator 118 may have the PWM signal turned on, the first rotor 112 may be rotating, and the second rotor 116 may be rotating. The first rotor 112 may receive a torque input from the input shaft 102, causing the input shaft 102 and the first rotor 112 to be rotating. The rotation of the first rotor 112 may cause the first stator 114 to generate electrical power. The PWM signal turned on to the first stator 114 may cause the first power electronics unit 202 to charge the rechargeable battery 206 using the electrical power from the first stator 114. The PWM signal turned on to the second stator 118 may cause the second power electronics unit 204 to supply electrical power to the second stator 118. The electrical power supplied to the second stator 118 may cause the second rotor 116 to rotate together with the output shaft 104. The lockup clutch 106 being open may prevent the input shaft 102 and the first rotor 112 from being locked to the speed and/or power of the output shaft 104 and the second rotor 116. Instead, the power may be transferred between the input shaft 102 and the output shaft 104 in sequence through the first axial flux machine 108, the first power electronics unit 202, the rechargeable battery 206, the second power electronics unit 204, and the second axial flux machine 110. The input shaft 102 may provide torque to the first axial flux machine 108, generate power through inverter, and provide the power back to second axial flux machine 110 out to the output shaft 104. The first axial flux machine 108 and the second axial flux machine 110 may be used as clutch between the input shaft 102 and the output shaft 104. The mode 201-2 may be beneficial when in a stall condition or when it is undesirable to lock the input shaft 102 to the output shaft 104. The input shaft 102 and the first rotor 112 may have a difference in rotational speed and/or power than the output shaft 104 and the second rotor 116. The mode 201-2 may also be used to rotate the input shaft 102 using the first axial flux machine 108 when starting the internal combustion engine 302 while separately rotating the output shaft 104 using the second axial flux machine 110 to provide seamless propulsion. The mode 201-2 may also be used by the first axial flux machine 108 and the second axial flux machine 110 to brake the rotation of the input shaft 102 and the output shaft 104 via regeneration at different rotational speeds.

The mode 201-3 may be a motor assist or regeneration mode. In the mode 201-3, the lockup clutch 106 may be closed, the first stator 114 may have the PWM signal turned on, the second stator 118 may have the PWM signal turned on, the first rotor 112 may be rotating, and the second rotor 116 may be rotating. The lockup clutch 106 being closed may lock the output shaft 104 to the input shaft 102, such that the input shaft 102, the output shaft 104, the first rotor 112, and the second rotor 116 are each rotating at a same speed. The PWM signals may cause the first axial flux machine 108 and the second axial flux machine 110 to assist in rotating the input shaft 102 and the output shaft 104 via motoring. For example, the electrical power supplied to the first axial flux machine 108 and the second axial flux machine 110 may cause the first rotor 112 and the second rotor 116 to increase the torque of the input shaft 102 and the output shaft 104. The PWM signals may cause the first axial flux machine 108 and the second axial flux machine 110 to brake the input shaft 102 and the output shaft 104 via regeneration. For example, the rotation of the first rotor 112 and the second rotor 116 may cause the first axial flux machine 108 and the second axial flux machine 110 to generate the electrical power for recharging the rechargeable battery 206. Thus, the rechargeable battery 206 may be a secondary power input (e.g., a motor assist) to the input shaft 102 and a secondary power output to the output shaft 104 (e.g., regeneration) when draining or charging, respectively.

The mode 201-4 may be an auxiliary power mode and/or an engine-start mode. In the mode 201-4, the lockup clutch 106 may be open, the first stator 114 may have the PWM signal turned on, the second stator 118 may have the PWM signal turned off, the first rotor 112 may be rotating, and the second rotor 116 may be static. The lockup clutch 106 being opened may unlock the output shaft 104 from the input shaft 102, such that the output shaft 104 and the second rotor 116 are stationary. In the auxiliary power mode, the input shaft 102 may be the torque input, causing the rotation of the first rotor 112. The rotation of the first rotor 112 may cause the first stator 114 to generate electrical power. The PWM signal turned on to the first stator 114 may cause the first power electronics unit 202 to charge the rechargeable battery 206 using the electrical power from the first stator 114. In the engine-start mode, the input shaft 102 may be the torque output. The PWM signal turned on to the first stator 114 may cause the first power electronics unit 202 to supply electrical power to the first stator 114. The first axial flux machine 108 may then rotate the first rotor 112. The rotation of the first rotor 112 may rotate the input shaft 102. In this regard, the first axial flux machine 108 may act as a starter motor.

The mode 201-5 may be an internal combustion engine-only mode. In the mode 201-5, the lockup clutch 106 may be closed, the first stator 114 may have the PWM signal turned off, the second stator 118 may have the PWM signal turned off, the first rotor 112 may be rotating, and the second rotor 116 may be rotating. The lockup clutch 106 being closed may lock the output shaft 104 to the input shaft 102, such that the input shaft 102, the output shaft 104, the first rotor 112, and the second rotor 116 are each rotating at a same speed. The PWM signals being off may prevent the first axial flux machine 108 and the second axial flux machine 110 from assisting in motor and/or regenerating power. One challenge with the mode 201-5 may be that the first axial flux machine 108 and/or the second axial flux machine 110 may generate voltage at higher speeds which is not suppressed by the PWM signals.

The mode 201-1, a mode 201-2, a mode 201-3, a mode 201-4, and/or the mode 201-5 may be further understood with reference to FIGS. 2B-2F. FIGS. 2B-2F depict the respective of the mode 201-1, a mode 201-2, a mode 201-3, a mode 201-4, and/or the mode 201-5. The lockup clutch 106 being open is indicated by the clutch plates being separated and being closed is indicated by the clutch plates being coupled together. The first stator 114 and the second stator 118 with the PWM signal off is indicated by the no change in the line-weight and the PWM signal on is indicated by the change in the line-weight. The input shaft 102, the output shaft 104, the first rotor 112, and the second rotor 116 being static are indicated by no change in the line-weight and being rotated are indicated by the increase in the line-weight.

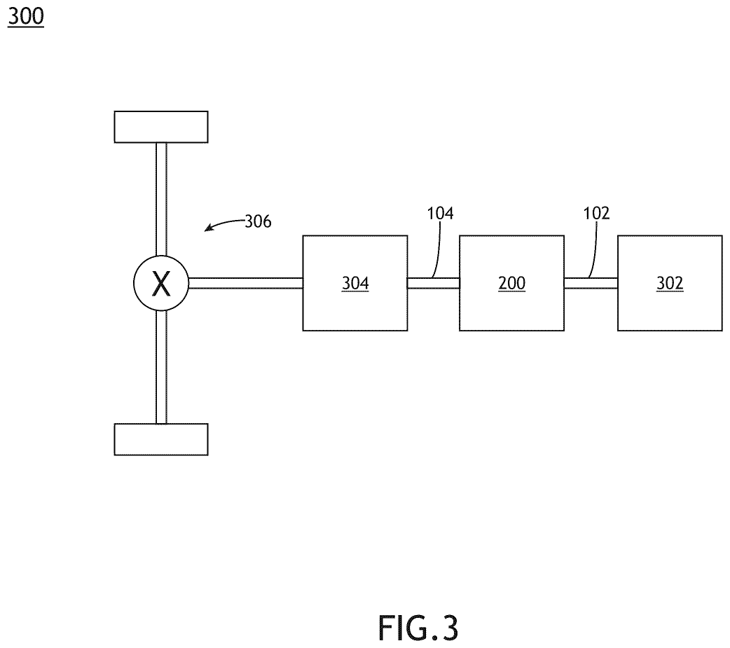

FIG. 3 illustrates a hybrid powertrain 300, in accordance with one or more embodiments of the present disclosure. The hybrid powertrain 300 may include one or more components, such as, but not limited to, the hybrid drive 200, an internal combustion engine 302, a transmission 304, and/or a driveline 306.

The hybrid module 100 may be a P2 hybrid module and couple between the internal combustion engine 302 and the transmission 304. The hybrid module 100 may be selectively operable to transmit torque from the internal combustion engine 302 to the transmission 304, directly drive the transmission 304, and/or start the internal combustion engine 302.

The input shaft 102 may be affixed to the internal combustion engine 302. The input shaft 102 may be affixed to the internal combustion engine 302. For example, the input shaft 102 may be affixed to a crankshaft (not depicted) of the internal combustion engine 302. For instance, the input shaft 102 may be affixed with the crankshaft via a drive plate (not depicted). The internal combustion engine 302 may axially constrain the input shaft 102 and the first rotor 112 to maintain the gap in the first axial flux machine 108. The input shaft 102 may receive torque from the internal combustion engine 302 when the internal combustion engine 302 is running. The input shaft 102 may also start the internal combustion engine 302.

The output shaft 104 may be affixed to the transmission 304. For example, the output shaft 104 may be affixed to a transmission input shaft (not depicted) of the transmission 304. The hybrid module 100 may be configured to rotate the transmission 304. The hybrid module 100 may rotate the transmission 304 by rotating the output shaft 104. The transmission 304 may or may not axially constrain the output shaft 104 and the second rotor 116. For example, the transmission 304 may be coupled to the output shaft 104 with a spline which may permit axial movement. The thrust bearing 130 may be beneficial to maintain the axial constraint.

The hybrid module 100 may mechanically lock the transmission 304 to the internal combustion engine 302 via the input shaft 102, the lockup clutch 106, and the output shaft 104 when the lockup clutch 106 is closed. When the lockup clutch 106 is open, the transmission 304 is not mechanically connected to the internal combustion engine 302.

The modes of the hybrid module 100 may provide various benefits when operating the hybrid powertrain 300. The mode 201-1 may be beneficial to achieve minimal power losses by circumventing the first axial flux machine 108 and the internal combustion engine 302. The mode 201-2 and/or the mode 201-3 may be beneficial when the internal combustion engine 302 has a powerband at which the internal combustion engine 302 is more efficient and a throttle control is instructing to change the speed of the transmission 304 outside of the powerband (e.g., to achieve the speed differential, to regenerate, and/or to assist with motoring). The mode 201-2 may also be beneficial to perform engine starts by rotating the input shaft 102 via the first axial flux machine 108 while the second axial flux machine 110 is motoring the output shaft 104. The mode 201-4 may be beneficial for charging the rechargeable battery 206 when the transmission 304 is stationary (e.g., the auxiliary power mode) and/or for starting the internal combustion engine 302 (e.g., the engine-start mode). The mode 201-5 may be beneficial when operating the internal combustion engine at low speeds.

The transmission 304 may drive the driveline 306 of the hybrid powertrain 300. The transmission 304 may be a multi-speed vehicle transmission. The transmission 304 may transmit torque to the driveline 306.

Referring generally again to the figures. The hybrid module 100 and/or the hybrid drive 200 may enable coupling the internal combustion engine 302 and the transmission 304 without a torque converter. Removing the torque converter from the hybrid powertrain 300 may be beneficial to prevent requiring custom transmission housings. The hybrid module 100 enables the removal of the torque converter/launch clutch, and the K0 clutch, while maintaining all necessary driving/auxiliary power modes. The hybrid module 100 may also provide possible greater than 2 torque ratio, and higher efficiency transfer of power than a traditional torque converter. The hybrid module 100 may be packaged roughly the same size as a traditional torque converter which may allow for minimal/no modifications to current transmission architectures while providing better efficiency of torque transfer/torque multiplication than the torque converter, and does not require use of a K0 to disconnect the internal combustion engine 302 from the transmission 304 while maintaining all relevant drive modes of a P2 hybrid module.

The hybrid module 100 may include one or more cooling channels (not depicted). The cooling channels may cool the first axial flux machine 108 and/or the second axial flux machine 110. For example, the support 120 may include the cooling channels. The cooling channels in the support 120 may be disposed axially between the first stator 114 and the second stator 118. The cooling channels may carry oil for cooling heat generated by the electrical current in the first stator 114 and the second stator 118.

The hybrid powertrain 300 may be beneficial for hybrid electric vehicles (HEV). The HEV may be a vehicle having two or more prime movers of more than one type for mutual or common propulsion, e.g. the axial flux motors and the internal combustion engine 302, that are either singularly or in combination used for propulsion of the HEV. The hybrid module 100 may be a series-parallel switching type powertrain may be a series-parallel type in which the mode can be switched between series mode and parallel mode. The internal combustion engine 302 may be directly connected to the first axial flux machine 108. The second axial flux machine 110 may be connected to the transmission 304. The lockup clutch 106 may couple between the axial flux machines via the input shaft 102 and the output shaft 104. In the series mode, the lockup clutch 106 will be unlocked and the second axial flux machine 110 will drive the transmission 304 by using the electric power generated by the first axial flux machine 108. In the parallel mode, the lockup clutch 106 will be engaged and the engine directly drives the wheels with or without assistance by the motor generators.

Radial bearings may refer to any bearing which may bear a radial load. Similarly, thrust bearings may refer to any bearing which may bear an axial load. The radial bearings and/or the thrust bearings may include plain bearings (e.g., bushings), ball bearings, roller bearings, or the like.

One skilled in the art will recognize that the herein described components operations, devices, objects, and the discussion accompanying them are used as examples for the sake of conceptual clarity and that various configuration modifications are contemplated. Consequently, as used herein, the specific exemplars set forth and the accompanying discussion are intended to be representative of their more general classes. In general, use of any specific exemplar is intended to be representative of its class, and the non-inclusion of specific components, operations, devices, and objects should not be taken as limiting.

As used herein, the term “axial” and derivatives thereof, such as “axially,” shall be understood to refer to a direction along the axis. The term “coaxial” shall be understood to refer to a common axis. Further, the term “radial” and derivatives thereof, such as “radially,” shall be understood in relation to the axis. For example, “radially outward” refers to further away from the axis, while “radially inward” refers to nearer to the axis. The term “circumference” or derivatives thereof, such as “circumferentially”, may also be defined in reference to the center axis.

As used herein, directional terms such as “top,” “bottom,” “over,” “under,” “upper,” “upward,” “lower,” “down,” and “downward” are intended to provide relative positions for purposes of description, and are not intended to designate an absolute frame of reference. Various modifications to the described embodiments will be apparent to those with skill in the art, and the general principles defined herein may be applied to other embodiments

With respect to the use of substantially any plural and/or singular terms herein, those having skill in the art can translate from the plural to the singular and/or from the singular to the plural as is appropriate to the context and/or application. The various singular/plural permutations are not expressly set forth herein for sake of clarity.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. As such, to the extent any embodiments are described as less desirable than other embodiments or prior art implementations with respect to one or more characteristics, these embodiments are not outside the scope of the disclosure and can be desirable for particular applications.

### LIST OF REFERENCE NUMBERS

100 hybrid module
101 center axis
102 input shaft
104 output shaft
106 lockup clutch
108 first axial flux machine
110 second axial flux machine
112 first rotor
114 first stator
116 second rotor
118 second stator
120 support
122 first three-phase connection
124 second three-phase connection
126 first radial bearing
128 second radial bearing
130 thrust bearing
132 damper
200 hybrid drive
201-1 mode
201-2 mode
201-3 mode
201-4 mode
201-5 mode
202 first power electronics unit
204 second power electronics unit
206 rechargeable battery
300 hybrid powertrain
302 internal combustion engine
304 transmission
306 driveline

What is claimed:

1. A hybrid module comprising:
an input shaft;
an output shaft;
a lockup clutch being a closeable and openable coupling between the input shaft and the output shaft;
a first axial flux machine comprising a first rotor and a first stator, the input shaft and the first rotor being affixed together, the first rotor and the first stator being axially offset, radially aligned, and configured to magnetically couple together;
a second axial flux machine comprising a second rotor and a second stator, the output shaft and the second rotor being affixed together, the second rotor and the second stator being axially offset, radially aligned, and configured to magnetically couple together, the first axial flux machine and the second axial flux machine being configurable as motors and generators independently of each other; and
a support, the first stator, the second stator, and the support being affixed together, the input shaft, the first rotor, the output shaft, and the second rotor being radially constrained to the support, the input shaft, the output shaft, the lockup clutch, the first axial flux machine, the second axial flux machine, and the support being coaxial.

2. The hybrid module of claim 1, wherein the lockup clutch is one of a friction clutch, a disc clutch, or a hydrostatic clutch.

3. The hybrid module of claim 1, wherein the input shaft and the first rotor are affixed together at an outer diameter of the first rotor, wherein the output shaft and the second rotor are affixed together at an inner diameter of the second rotor.

4. The hybrid module of claim 1, comprising a first radial bearing and a second radial bearing, wherein the input shaft and the first rotor are radially constrained to the support via the first radial bearing, wherein the output shaft and the second rotor are radially constrained to the support via the second radial bearing.

5. The hybrid module of claim 4, wherein an inner diameter of the first rotor abuts with an outer diameter of the first radial bearing, wherein an outer diameter of the output shaft abuts with an inner diameter of the second radial bearing.

6. The hybrid module of claim 1, comprising a thrust bearing, wherein the output shaft and the second rotor are axially constrained to the input shaft via the thrust bearing.

7. The hybrid module of claim 6, wherein an axial side of the second rotor which is facing away from the second stator abuts the thrust bearing, wherein the thrust bearing is disposed radially outwards of the lockup clutch.

8. The hybrid module of claim 1, wherein the first axial flux machine and the second axial flux machine are axially offset.

9. The hybrid module of claim 8, wherein the first rotor and the second rotor are disposed at opposing axial ends of the first axial flux machine and the second axial flux machine, wherein the first stator is axially disposed between the first rotor and the second stator, wherein the second stator is axially disposed between the first stator and the second rotor.

10. The hybrid module of claim 9, wherein the first axial flux machine and the second axial flux machine are radially aligned.

11. The hybrid module of claim 9, wherein the first axial flux machine and the second axial flux machine are each a single-stator, single-rotor configuration, wherein the first stator comprises opposing axial sides which face towards respective of the first rotor and the second stator, wherein the second stator comprises opposing axial sides which face towards respective of the first stator and the second rotor.

12. The hybrid module of claim 1, comprising a first three-phase connection and a second three-phase connection, wherein the first rotor and the second rotor are permanent magnet rotors, wherein the first stator and the second stator are wound armature stators, wherein the first three-phase connection and the second three-phase connection are connected to respective of the first stator and the second stator, wherein at least a portion of the first three-phase connection and the second three-phase connection are disposed within the support.

13. The hybrid module of claim 1, wherein the first axial flux machine and the second axial flux machine are magnetically insulated from each other.

14. The hybrid module of claim 13, comprising a non-magnetic material, wherein the non-magnetic material is axially disposed between the first stator and the second stator.

15. The hybrid module of claim 1, comprising a damper, wherein the damper is configured to damp torsional vibrations between the input shaft and the output shaft.

16. The hybrid module of claim 1, wherein the lockup clutch and the second axial flux machine are configured to damp torsional vibrations between the input shaft and the output shaft.

17. A hybrid drive comprising:
a hybrid module comprising:
an input shaft;
an output shaft;
a lockup clutch being a closeable and openable coupling between the input shaft and the output shaft;
a first axial flux machine comprising a first rotor and a first stator, the input shaft and the first rotor being affixed together, the first rotor and the first stator being axially offset, radially aligned, and configured to magnetically couple together;
a second axial flux machine comprising a second rotor and a second stator, the output shaft and the second rotor being affixed together, the second rotor and the second stator being axially offset, radially aligned, and configured to magnetically couple together, the first axial flux machine and the second axial flux machine being configurable as motors and generators independently of each other; and
a support, the first stator, the second stator, and the support being affixed together, the input shaft, the first rotor, the output shaft, and the second rotor being radially constrained to the support, the input shaft, the output shaft, the lockup clutch, the first axial flux machine, the second axial flux machine, and the support being coaxial;
a rechargeable battery;
a first power electronics unit connected to the first stator and the rechargeable battery; and
a second power electronics unit connected to the second stator and the rechargeable battery, the first power electronics unit and the second power electronics unit configured to generate a pulse width modulation signal (PWM signal) to regulate an electrical power supplied to or generated by respective of the first axial flux machine and the second axial flux machine.

18. The hybrid drive of claim 17, wherein one of:
the first power electronics unit and the second power electronics unit are housed in separate units; or
the first power electronics unit and the second power electronics unit are housed in a common unit.

19. The hybrid drive of claim 17, wherein the hybrid module is configurable with at least one of:
a mode (201-1) wherein the lockup clutch is open, the first stator has the PWM signal turned off, the second stator has the PWM signal turned on, the first rotor is static, and the second rotor is rotating;
a mode (201-2) wherein the lockup clutch is open, the first stator has the PWM signal turned on, the second stator has the PWM signal turned on, the first rotor is rotating, and the second rotor is rotating;
a mode (201-3) wherein the lockup clutch is closed, the first stator has the PWM signal turned on, the second stator has the PWM signal turned on, the first rotor is rotating, and the second rotor is rotating;
a mode (201-4) wherein the lockup clutch is open, the first stator has the PWM signal turned on, the second stator has the PWM signal turned off, the first rotor is rotating, and the second rotor is static; or
a mode (201-5) wherein the lockup clutch is closed, the first stator has the PWM signal turned off, the second stator has the PWM signal turned off, the first rotor is rotating, and the second rotor is rotating.

20. A hybrid powertrain comprising:
a hybrid drive comprising:
a hybrid module comprising:
an input shaft;
an output shaft;
a lockup clutch being a closeable and openable coupling between the input shaft and the output shaft;
a first axial flux machine comprising a first rotor and a first stator, the input shaft and the first rotor being affixed together, the first rotor and the first stator being axially offset, radially aligned, and configured to magnetically couple together;
a second axial flux machine comprising a second rotor and a second stator, the output shaft and the second rotor being affixed together, the second rotor and the second stator being axially offset, radially aligned, and configured to magnetically couple together, the first axial flux machine and the second axial flux machine being configurable as motors and generators independently of each other; and
a support, the first stator, the second stator, and the support being affixed together, the input shaft, the first rotor, the output shaft, and the second rotor being radially constrained to the support, the input shaft, the output shaft, the lockup clutch, the first axial flux machine, the second axial flux machine, and the support being coaxial;
a rechargeable battery;
a first power electronics unit connected to the first stator and the rechargeable battery; and
a second power electronics unit connected to the second stator and the rechargeable battery, the first power electronics unit and the second power electronics unit configured to generate a pulse width modulation signal (PWM signal) to regulate an electrical power supplied to and generated by respective of the first axial flux machine and the second axial flux machine;
an internal combustion engine affixed to the input shaft; and
a transmission affixed to the output shaft.
